(19) United States
(12) Patent Application Publication
(10) Pub. No.: US 2026/0279649 A1
(43) Pub. Date: Sep. 17, 2026

(54) AN INDUCTOR AND A METHOD OF PROVIDING AN INDUCTOR

(71) Applicant: ETA GREEN POWER LIMITED, Hethel (GB)

(72) Inventors: Liam Bowman, Hethel (GB); Robert Wood, Hethel (GB); Sean Burke, Hethel (GB)

(21) Appl. No.: 19/673,619

(22) Filed: May 11, 2026

Related U.S. Application Data
(62) Division of application No. 18/070,865, filed on Nov. 29, 2022.

(30) Foreign Application Priority Data
Nov. 30, 2021 (GB) 2117307.5

(51) Int. Cl. H01F 27/28; H01F 27/24; H01F 41/04

(52) U.S. Cl. CPC H01F 27/28; H01F 27/24; H01F 41/04

(57) ABSTRACT

The present invention relates to the inductors, for example, flat ribbon inductors and methods of forming thereof. An aspect of the disclosure provides an inductor comprising: a helical conductor a core having a core magnetic reluctance, the core comprising: a first core portion; a second core portion; and, a gap disposed between the first core portion and the second core portion and enclosed by the helical conductor, wherein the gap is configured to provide a gap magnetic reluctance wherein the gap magnetic reluctance is greater than the core magnetic reluctance; wherein the helical conductor has: a first region of the conductor which encloses part of the core, wherein the first region comprises a first pitch; and, a second region of the conductor which encloses the gap wherein the second region comprises a second pitch, wherein the second pitch is greater than the first pitch; wherein, in use, the second region of the conductor is configured to reduce a magnitude of interaction between the second region of the conductor and an electromagnetic field generated around the gap.

### CROSS REFERENCE TO RELATED APPLICATION

This application is a divisional of and claims the priority and benefit of U.S. patent application Ser. No. 18/070,865, filed 29 Nov. 2022, which claims priority to United Kingdom Patent Application No. 2117307.5, filed 30 Nov. 2021, the disclosures of which are incorporated herein by reference in their entirety.

### FIELD OF INVENTION

The present invention relates to the inductors, for example, flat ribbon inductors and methods of forming thereof.

### BACKGROUND

Typical inductors comprise a helical conductor wherein the helical conductor has a constant cross-sectional area therethrough and a constant pitch and a core comprising a gap. The conductor typical receives a current with a high power density which generates a fringing field (e.g. electromagnetic field) in the gap. The fringing field may interact with the conductor thereby generating eddy currents in the conductor which result in a loss of power in the inductor.

EP20204342.8, which has granted as European Patent No. 3992996, describes apparatus which aim to reduce the magnitude of the interaction between the fringing field and the conductor.

### SUMMARY

Aspects of the invention are set out in the independent claims and optional features are set out in the dependent claims. Aspects of the disclosure may be provided in conjunction with each other, and features of one aspect may be applied to other aspects.

An aspect of the disclosure provides an inductor comprising: a helical conductor; a core having a core magnetic reluctance, the core comprising: a first core portion; a second core portion; and, a gap disposed between the first core portion and the second core portion and enclosed by the helical conductor, wherein the gap is configured to provide a gap magnetic reluctance wherein the gap magnetic reluctance is greater than the core magnetic reluctance; wherein the helical conductor has: a first region of the conductor which encloses part of the core, wherein the first region comprises a first pitch; and, a second region of the conductor which encloses the gap wherein the second region comprises a second pitch, wherein the second pitch is greater than the first pitch; wherein, in use, the second region of the conductor is configured to reduce a magnitude of interaction between the second region of the conductor and an electromagnetic field generated around the gap.

The electromagnetic field may be referred to herein as a fringing field. The electromagnetic field may be a magnetic field. The present aspect may provide a helical conductor wherein the volume of the conductor disposed in a volume comprising a fringing field is comparatively reduced in comparison to typical helical conductors comprising a single pitch. Advantageously, the magnitude of interaction (i.e. electromagnetic interaction) between the fringing field and the conductor is comparatively reduced relative to typical conductors comprising a single pitch.

The gap may have a gap length wherein the gap length is the shortest distance through the gap between the first core portion and the second core portion and the second pitch may be greater than or equal to the gap length. Providing a second region with a pitch which is greater than the length of the gap may reduce the volume of the intersection between the conductor and the fringing field which in turn may reduce the interaction of the fringing fields and the conductor in comparison to conductors with a second pitch less than the gap length.

The conductor may have a rectangular cross-section comprising two sides with length X and two sides with length Y, wherein length X is greater than length Y. The second region of the conductor is arranged so that one of the sides of the conductor with length X forms part of the inner radial surface. Advantageously, disposing the second region of the conductor such that the longest side of the conductor forms the inner radial surface may increase the inner radius of the second region, which may increase the distance between the second region and the fringing field which may reduce the interaction between the conductor and the fringing field.

The radial distance between the central longitudinal axis and the inner radial surface is greater at the second region of the conductor than the first region of the conductor. Advantageously, disposing the second region of the conductor such that the inner radial surface has a radial distance greater than that of the first region may increase the distance between the second region and the fringing field which may reduce the interaction between the conductor and the fringing field.

An aspect of the disclosure provides a method of forming an inductor, the method comprising: disposing a first region of a conductor with around a core, wherein the first region of the conductor is disposed around the core with a first pitch; disposing a second region of a conductor with around a gap in the core, wherein the second region of the conductor is disposed around the gap in the core with a second pitch, wherein the second pitch is greater than the first pitch.

The gap may have a gap length, wherein the gap length is the shortest distance through the gap between the first portion and the second portion and, the second pitch is greater than or equal to the gap length. Providing a second region with a pitch which is greater than the length of the gap may reduce the volume of the intersection between the conductor and the fringing field which in turn may reduce the interaction of the fringing fields and the conductor in comparison to conductors with a second pitch less than the gap length.

An aspect of the disclosure provides an inductor comprising: a helical conductor comprising: a central longitudinal axis; an inner radial surface; and, an outer radial surface; a core having a core magnetic reluctance, the core comprising: a first core portion; a second core portion; and, a gap disposed between the first portion and the second portion and enclosed by the inner radial surface of the conductor, wherein the gap is configured to provide a gap magnetic reluctance wherein the gap magnetic reluctance is greater than the core magnetic reluctance; wherein the helical conductor has: a first region of the conductor which encloses part of the core, wherein the first region comprises a first pitch, and wherein the first region of the conductor has a first cross-sectional area; and, a second region of the conductor which encloses the gap wherein the second region comprises a second pitch, wherein the second pitch is greater than the first pitch, and wherein the second region of the conductor has a second cross-sectional area wherein the second region cross-sectional area is less than the first cross-sectional area; wherein, in use, the second region of the conductor is configured to reduce a magnitude of interaction between the second region of the conductor and an electromagnetic field generated around the gap.

The present aspect provides an inductor wherein the volume of the helical conductor (comprising a first region with a first cross-sectional area and a second region with a second cross-sectional area, wherein the second cross-sectional area is less than the first cross-sectional area) which is disposed in the volume wherein the fringing field is disposed is comparatively reduced in comparison to typical helical conductors comprising a single cross-sectional area. Advantageously, the magnitude of interaction (i.e. electromagnetic interaction) between the fringing field and the conductor is comparatively reduced relative to typical conductors comprising a single cross-sectional area.

The radial distance between the central longitudinal axis and the inner radial surface may be greater at the second region of the conductor than the first region of the conductor. Advantageously, increasing the distance between the second region and the fringing field may reduce the electromagnetic interaction between the conductor and the fringing field.

An aspect of the disclosure provides a method of forming an inductor, the method comprising: disposing a first region of a conductor with around a core, wherein the first region of the conductor has first cross-sectional area; disposing a second region of a conductor around a gap in the core, wherein the second region of the conductor has a second cross-sectional area wherein the second cross-sectional area is less than the first cross-sectional area.

The method may comprise: providing a conductor having a first region and a second region; and, compressing second region of an inductor.

The gap may have a gap length, wherein the gap length is the shortest distance through the gap between the first portion and the second portion; and, the second pitch is greater than or equal to the gap length.

The helical conductor may comprise: a central longitudinal axis; an inner radial surface; and, an outer radial surface. In examples, the gap disposed between the first core portion and the second core portion is enclosed by the inner radial surface of the helical conductor.

### DRAWINGS

Embodiments of the disclosure will now be described, by way of example only, with reference to the accompanying drawings, in which:

FIG. 1A illustrates a perspective view of a conductor for an inductor;

FIG. 1B illustrates an axial plan view of the conductor shown in FIG. 1A;

FIGS. 1C and 1D illustrates a lateral side plan view of the conductor shown in FIG. 1A;

FIG. 1E illustrates a lateral top plan view of the conductor shown in FIG. 1A;

FIG. 2A to 2C illustrate cross-sectional plan views of a symmetric core for an inductor;

FIG. 3A illustrates a first cross-sectional plan view of an inductor along plane A-A shown with respect to the conductor in FIG. 1C;

FIG. 3B illustrates a second cross-sectional plan view of an inductor along plane B-B shown with respect to the conductor in FIG. 1E;

FIG. 4A illustrates a cross-sectional plan view of a portion of a conductor for an inductor;

FIG. 4B illustrates a cross-sectional plan view of the conductor of FIG. 4A;

FIG. 5 illustrates a cross-sectional plan view of the conductor of FIG. 4 disposed in the symmetric core shown in FIGS. 2A to 2C; and

FIG. 6 illustrates a cross-sectional plan view of an asymmetric core for an inductor.

### DESCRIPTION

Inductors comprise a core comprising a first core portion and a second core portion arranged to provide a gap therebetween. The first core portion and second core portion are arranged to enclose a helical conductor (e.g. the core portions are disposed around an outer radial surface of the helical conductor) and the helical conductor encloses at least part of at least one of the first core portion and the second core portion (e.g. cylindrical projections described in more detail below). The helical conductor is also arranged to enclose a gap.

When a current is flowed through the conductor a magnetic field is generated which surrounds the conductor and passes through the core and the gap in the core. In other words, a magnetic circuit is generated in the inductor when a current flows through the conductor. The inductance of a circuit depends on the geometry of the current path as well as the magnetic permeability of nearby materials. An inductor is a component consisting of a wire or other conductor shaped to increase the magnetic flux through the circuit, usually in the shape of a coil or helix, with two terminals. Winding the wire into a coil increases the number of times the magnetic flux lines link the circuit, increasing the magnitude of the magnetic field (e.g. field line density) and thus the inductance. The greater the number of turns in the conductor, the greater the inductance in the magnetic circuit. The inductance also depends on the shape of the coil, separation of the turns, and many other factors. The core may comprise a ferromagnetic material like iron inside the coil, the magnetizing field from the coil will induce magnetization in the material, increasing the magnetic flux. The high permeability of a ferromagnetic core can increase the inductance of a coil by a factor of several thousand over what it would be without it.

When a current is flowed through the conductor a magnetic field is generated which, among other things, induces an electromagnetic field in and radially around the gap (a so-called fringing field). The fringing field may intersect regions of the helical conductor which results in an electromagnetic interaction between the fringing field and the helical conductor. This electromagnetic interaction induces eddy currents in these regions of the helical conductor. The eddy currents dissipate energy from the inductor (e.g. via heat) which is undesired and reduces the efficiency of the inductor.

Inductors described herein reduce the magnitude of the electromagnetic interaction between the fringing field and the inductor by providing a conductor which has a geometry configured to reduce the magnitude of the electromagnetic interaction e.g. conductors with less intersection (and thus a lesser interaction magnitude) between the fringing field and the conductor. Inductors described herein provide a conductor with at least one of: a large pitch at the gap (e.g. a pitch greater than a longitudinal length of the gap); and, a reduced cross-sectional area of the region of the conductor which surrounds the gap (e.g. relative to the cross-sectional of regions of the conductor which do not surround the gap.

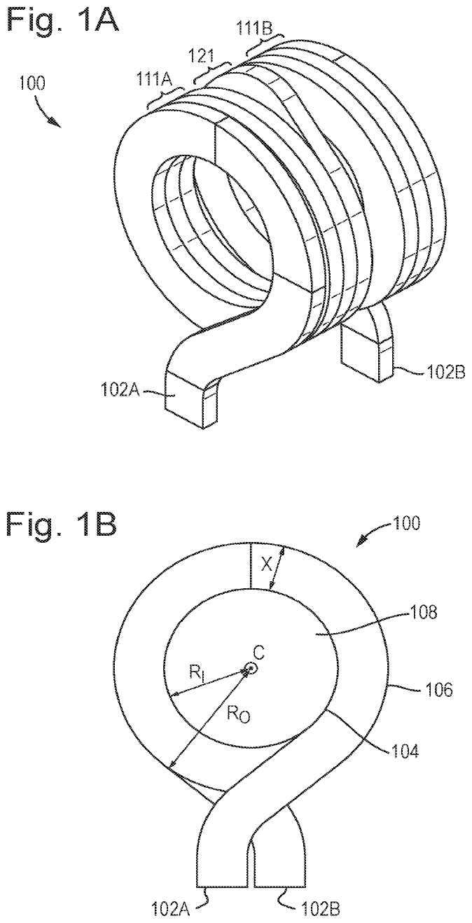

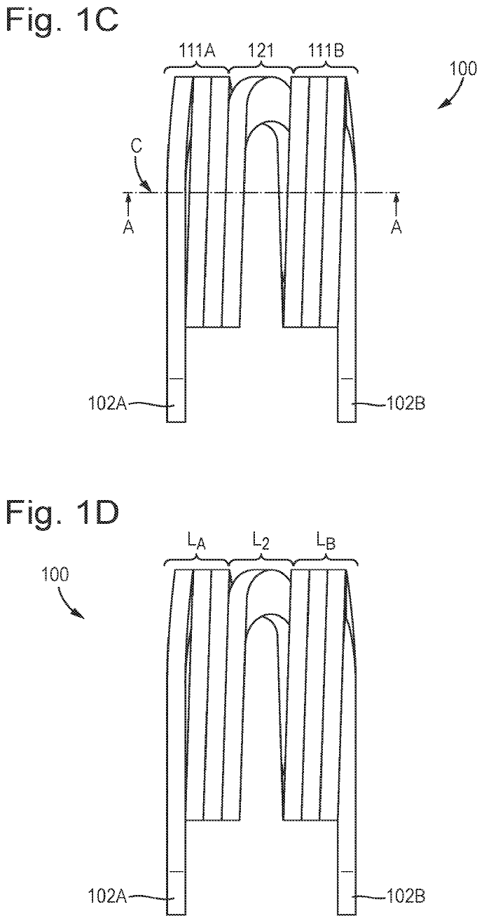

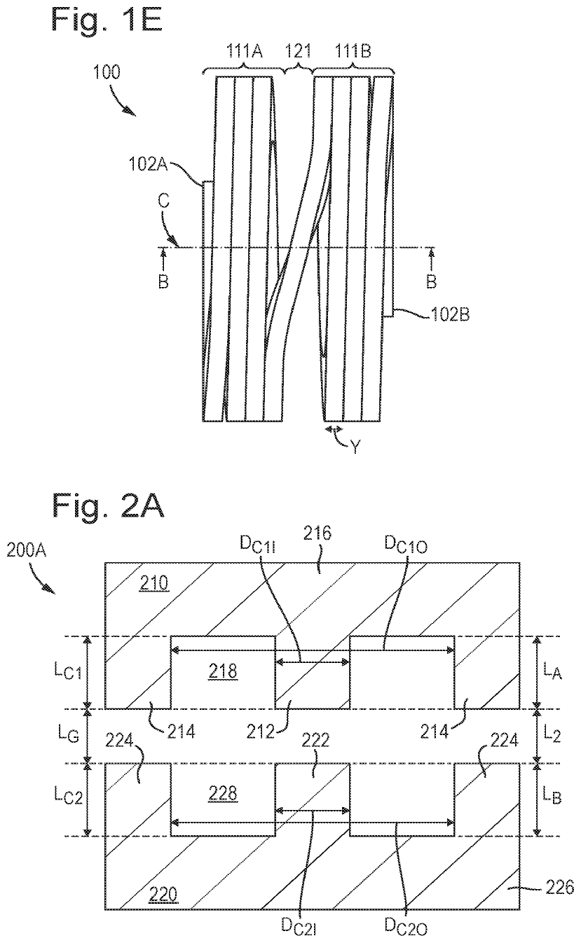

FIG. 1A illustrates a perspective view of a conductor for an inductor; FIG. 1B illustrates an axial plan view of the conductor shown in FIG. 1A; FIGS. 1C and 1D illustrates a lateral side plan view of the conductor shown in FIG. 1A; FIG. 1E illustrates a lateral top plan view of the conductor shown in FIG. 1A.

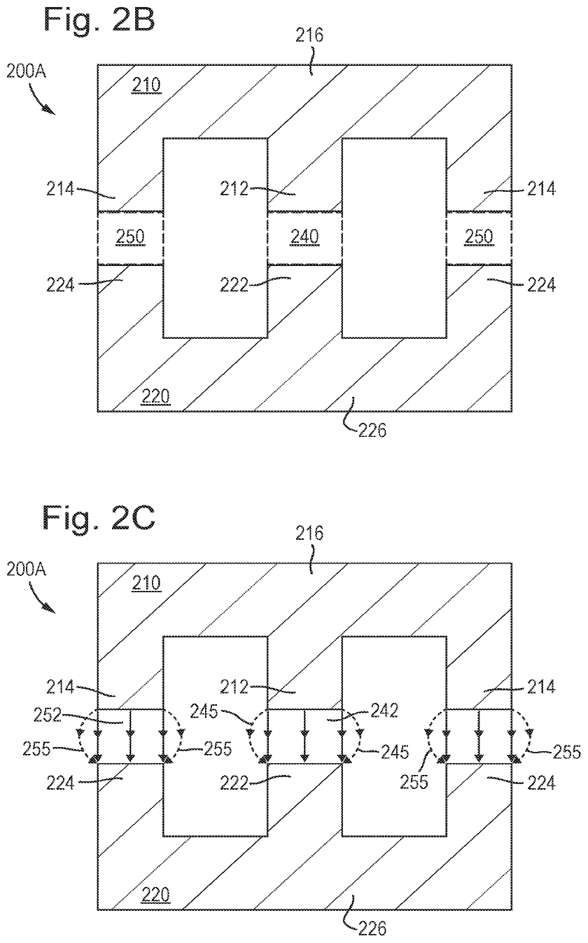

The inductor comprises the conductor 100 and a core. Example cores are illustrated in FIGS. 2A to 2C and FIG. 6.

The conductor 100 has a helical portion (comprising elements 151A, 121 and 151B) and has a pair of electrical contacts 102A, 102B. For example, the helical portion of the conductor 100 may be referred to as a helical conductor.

The conductor 100 has a rectangular cross-section. The rectangular cross-section is perpendicular to a local longitudinal axis of the conductor e.g. wherein the local longitudinal axis is disposed throughout the length of the conductor and when the conductor is helical (or has a helical portion) then the local longitudinal axis of the conductor has a helical shape which encircles a central longitudinal axis C (which is described in more detail below). The rectangular cross-section is the same size along the length of the conductor. The rectangular cross-section is characterised by two pairs of sides wherein the sides of each pair have lengths X (e.g. width) and Y (e.g. height) respectively. The length X is greater than length Y.

In examples, the length X may be equal to the length Y i.e. to give a conductor with a square cross section. In examples, the cross-section of the conductor may be circular. The circular cross-section is perpendicular to the local longitudinal axis of the conductor.

The helical conductor has a central longitudinal axis C. The helical conductor 100 has an inner radial surface 104. The inner radial surface 104 is disposed around the longitudinal axis C. The helical conductor has an inner radius R_{I} defined as the shortest distance between a given point on the longitudinal axis C and the inner radial surface 104. The helical conductor has an outer radial surface 106. The outer radial surface 106 is disposed around the longitudinal axis C. The helical conductor has an outer radius R_{O} defined as the shortest distance between a given point on the longitudinal axis C and the outer radial surface 106. The difference between the outer radius R_{O} and the inner radius R_{I} is equal to the width of the conductor X; R_{O}−R_{I}=X)

The helical conductor has a central longitudinal passage 108. The central longitudinal passage 108 is delimited by the inner radial surface 104 of the helical conductor.

The helical conductor comprises: a first region 111A and 111B; and, a second region 121. The first region 111A and 111B of the conductor comprises a first pitch. The second region 121 of the conductor comprises a second pitch wherein the second pitch is greater than the first pitch.

Herein the term pitch refers to a distance along the longitudinal axis C, over which a helix completes one full turn around the longitudinal axis C.

The first region of the conductor may be discontinuous e.g. the first region sandwiches the second region. In other words, the first region comprises two disconnected portions, an A portion 111A and a B portion 111B. The A portion 111A has a longitudinal length L_{A} parallel to the central longitudinal axis C. The B portion 111B has a longitudinal length L_{B} parallel to the central longitudinal axis C. The first region of the conductor has a longitudinal length L₁ which is equal to the sum of the longitudinal length L_{A} of the A portion 111A and the sum of the longitudinal length L_{B} of the B portion 111B; L₁=L_{A}+L_{B}.

The second region 121 of the conductor has a longitudinal length L₂, parallel to the longitudinal axis C.

In example, the first pitch of the first region may be the same as the second pitch in the second region and the first pitch and the second pitch may be greater than the gap length. The greater the difference between the second pitch and the gap length, the lower the interaction magnitude between the conductor and the fringing field.

The helical conductor has a total longitudinal length L_{T} parallel to the longitudinal axis C. The total longitudinal length L_{T} of the helical conductor is equal to the sum of the lengths of the first region L₁ and the second region L₂; L_{T}=L₁+L₂. In the example shown in FIGS. 1A to 1E, the total longitudinal length L_{T} of the helical conductor is equal to the sum of the longitudinal length L_{A} of the A portion 111A, the longitudinal length L_{B} of the B portion 111B, and the longitudinal length L2 of the second region 121; L_{T}=L_{A}+L_{B}+L₂. Put another way, the total longitudinal length L_{T} of the helical conductor is equal to the sum of the longitudinal length L₁ of the first region 111A & 111B and the longitudinal length L₂ of the second region 121; L_{T}=L₁+L₂.

The conductor 100 is configured to permit a current to flow therethrough e.g. when the conductor is connected to a source of electromotive force (EMF). The conductor 100 is configured to connect to a source of EMF. The electrical connections 102A and 102B are connectable to a source of EMF. The conductor 100 is configured to generate a magnetic field when a current flows therethrough wherein the magnetic field is disposed around the conductor e.g. magnetic field lines of the magnetic field form closed loops which pass through the central passage 108 around the outer radial surface 106 of the conductor and back through the central passage 108. In other words, the magnetic field lines are closed loops which enclose a portion of the conductor.

FIG. 2A to 2C illustrate cross-sectional plan views of a symmetric core for an inductor. In some examples, the core may be an asymmetric core such as that illustrated in FIG. 6.

The symmetric core 200A comprises: a first symmetric core portion 210; and, a second symmetric core portion 220.

The first symmetric core portion 210 comprises: a first end portion 216; a first cylindrical projection 212; and, a first annular cylindrical projection 214. The first cylindrical projection 212 is connected to the first end portion 216. The first annular cylindrical projection 214 is connected to the first end portion 216. The first cylindrical projection 212 and the first annular cylindrical projection 214 are disposed concentrically i.e. the first cylindrical projection 212 and the first annular cylindrical projection 214 are arranged so that a longitudinal axis of the first cylindrical projection 212 and a longitudinal axis of the first annular cylindrical projection 214 are parallel and coincident. The first cylindrical projection 212 and the first annular cylindrical projection 214 are disposed concentrically to thereby provide a first annular hollow 218 therebetween.

The first end portion 216 has a cylindrical shape and the first cylindrical projection 212 and the first annular cylindrical projection 214 are disposed on an axial face of the first end portion 216. The first end portion 216 has a diameter equal to the outer diameter of the first annular cylindrical projection 214.

The first cylindrical projection 212 has a diameter D_{C1I}. The first annular cylindrical projection 214 has an inner diameter D_{C1O}. The diameter D_{C1I} of the first cylindrical projection 212 is less than the inner diameter D_{C1O} of the first annular cylindrical projection 214.

The first cylindrical projection 212 has a length L_{C1}. In other words, the first cylindrical projection 212 extends longitudinally from the first end portion 216 by a length L_{C1}. The first annular cylindrical projection 214 has a length L_{C1}. In other words, the first annular cylindrical projection 214 extends longitudinally from the first end portion 216 by a length L_{C1}.

The first annular hollow defined by the first symmetric core portion 210 has: a length equal to the length L_{C1} of the first cylindrical projection 212; an inner diameter equal to the diameter D_{C1I} of the first cylindrical projection 212; an outer diameter equal to the inner diameter D_{C1O} of the first annular cylindrical projection 214.

The second symmetric core portion 220 comprises: a second end portion 226; a second cylindrical projection 222; and, a second annular cylindrical projection 224. The second cylindrical projection 222 is connected to the second end portion 226. The second annular cylindrical projection 224 is connected to the second end portion 226. The second cylindrical projection 222 and the second annular cylindrical projection 224 are disposed concentrically i.e. the second cylindrical projection 222 and the second annular cylindrical projection 224 are arranged so that a longitudinal axis of the second cylindrical projection 222 and a longitudinal axis of the second annular cylindrical projection 224 are parallel and coincident. The second cylindrical projection 222 and the second annular cylindrical projection 224 are disposed concentrically to thereby provide a second annular hollow therebetween.

The second end portion 226 has a cylindrical shape and the second cylindrical projection 222 and the second annular cylindrical projection 224 are disposed on an axial face of the second end portion 226. The second end portion 226 has a diameter equal to the outer diameter of the second annular cylindrical projection 224.

The second cylindrical projection 222 has a diameter D_{C2I}. The second annular cylindrical projection 224 has an inner diameter D_{C2O}. The diameter D_{C2I} of the second cylindrical projection 222 is less than the inner diameter D_{C2O} of the second annular cylindrical projection 224.

The second cylindrical projection 222 has a length L_{C2}. In other words, the second cylindrical projection 222 extends longitudinally from the second end portion 226 by a length L_{C2}. The second annular cylindrical projection 224 has a length L_{C2}. In other words, the second annular cylindrical projection 224 extends longitudinally from the second end portion 226 by a length L_{C2}.

The second annular hollow defined by the second symmetric core portion 220 has: a length equal to the length L_{C2} of the second cylindrical projection 222; an inner diameter equal to the diameter D_{C2I} of the second cylindrical projection 222; an outer diameter equal to the inner diameter D_{C2O} of the second annular cylindrical projection 224.

In the symmetric core 200A: the diameter D_{C1I} of the first cylindrical projection 212 is equal to the diameter D_{C2I} of the second cylindrical projection 222; the inner diameter D_{C1O} of the first annular cylindrical projection 214 is equal to the inner diameter D_{C2O} of the second annular cylindrical projection 224; the outer diameter of the first annular cylindrical projection 214 is equal to the outer diameter of the second annular cylindrical projection 224; the length L_{C1} of the first cylindrical projection 212 is equal to the length L_{C2} of the second cylindrical projection 222; the length of the first cylindrical annular projection 214 is equal to the length of the second cylindrical annular projection 224; the length L_{C1} of the first cylindrical projection 212 is equal to the longitudinal length L_{A} of the A portion of the helical conductor 121A; the length L_{C2} of the second cylindrical projection 222 is equal to the longitudinal length L_{A} of the B portion of the helical conductor 121B.

The diameter D_{C1I} of the first cylindrical projection 212 is less than or equal to twice the inner radius R_{I} of the conductor; D_{C1I} =2R_{I}. The diameter D_{C2I} of the second cylindrical projection 222 is less than or equal to twice the inner radius R_{I} of the conductor; D_{C2I}=2R_{I}. The inner diameter D_{C1O} of the first annular cylindrical projection 214 is greater than or equal to twice the outer radius R_{O} of the conductor; D_{C1O}=2R_{O}. The inner diameter D_{C2O} of the second annular cylindrical projection 224 is greater than or equal to twice the outer radius R_{O} of the conductor; D_{C1O}=2R_{O}.

The first symmetric core portion 210 and the second symmetric core portion 220 are arranged to provide a gap therebetween. The first symmetric core portion 210 and the second symmetric core portion 220 are arranged to provide an inner gap 240 directly between the first cylindrical projection 212 and the second cylindrical projection 222 and an outer gap 250 directly between the first annular cylindrical projection 214 and the second annular cylindrical projection 224.

The inner gap 240 refers to the region of space directly between the first cylindrical projection 212 and the second cylindrical projection 222. The inner gap 240 is a cylindrical gap of diameter D_{C1I} which is disposed between axial faces of the first cylindrical projection 212 and the second cylindrical projection 222. Put more abstractly, any straight line drawn between any point on an axial end face of the first cylindrical projection and any point on an axial end face of the second cylindrical projection is necessarily drawn within the inner gap 240.

The outer gap 250 refers to the region of space directly between the first annular cylindrical projection 212 and the second annular cylindrical projection 222. The outer gap 250 is an annular cylindrical gap of inner diameter D_{C1O} and outer diameter equal to the outer diameter of the first cylindrical projection, which is disposed between axial faces of the first annular cylindrical projection 214 and the second annular cylindrical projection 224.

In examples, the first symmetric core portion and the second symmetric core portion are arranged to provide an inner gap between the first cylindrical projection and the second cylindrical projection but so that there is no outer gap provided between the first annular cylindrical projection and the second annular cylindrical projection. In such examples, the annular cylindrical projection has a length greater than the length of the cylindrical projection. For example, the asymmetric core illustrated in FIG. 6 does not include an outer gap.

The gap provided between the first symmetrical core portion 210 and the second symmetric core portion 220 is configured to increase the magnetic reluctance of the core (e.g. the combined magnetic reluctance of combined system of the first symmetrical core portion 210 the second symmetrical core portion 220 and the gap). The inner gap 240 is configured to increase the magnetic reluctance of the core. The outer gap 250 is configured to increase the magnetic reluctance of the core.

Advantageously, increasing the magnetic reluctance of the core 200A comparatively increases the amount of energy stored in the core 200A (e.g. the energy stored in the combined system of the first symmetrical core portion 210 the second symmetrical core portion 220 and the gap). Energy is stored in the core 200A in the form of a magnetic field.

The symmetric core 200A is configured to engage a conductor, for example, the conductor 100 illustrated in FIG. 1A to 1E. The first annular hollow 218 defined by the first symmetric core portion 210 is configured to receive a portion of a conductor, for example, the A portion 151A of conductor 100. The second annular hollow 228 defined by the second symmetric core portion 220 is configured to receive a portion of a conductor, for example, the B portion 151B of conductor 100. The gap between the first symmetric core portion 210 and the second symmetric core portion 220 is configured to receive a portion of the conductor, for example, the second region 151B of the conductor 100. Put another way, a portion of the conductor is configured to be disposed between the first symmetric core portion 210 and the second symmetric core portion 220, for example, the second region 121 of the conductor 100. That is, a portion of the conductor is disposed between the first symmetric core portion 210 and the second symmetric core portion 220 but is not disposed in any of the first annular hollow, the second annular hollow, the inner gap or the outer gap.

When a conductor is disposed within the symmetric core 200A and there is a current flow through the conductor and a magnetic field is generated around the conductor. The symmetric core 200B is arranged so that at least some of the magnetic field lines of the generated magnetic field pass through the symmetric core 200A.

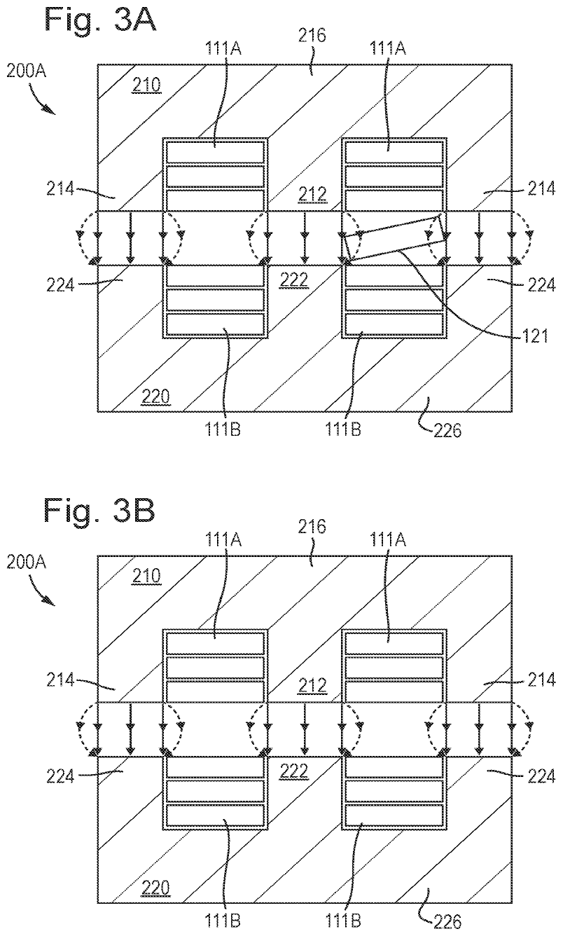

For a helical conductor disposed within the symmetric core (e.g. the conductor illustrated in FIGS. 1A to 1E disposed within the symmetric core as illustrated in FIGS. 3A and 3B), closed loop magnetic field lines pass from a central passage of the conductor, around an outer radial face of the conductor and back into the central passage of the conductor. The symmetric core 200A is configured to intercept the magnetic field lines generated by the current flow through conductor e.g. in use the symmetric core 200A is arranged so that part of magnetic field lines of a magnetic field generated by the current flow of the conductor are located within the symmetric core (i.e. in the first symmetric core portion 210 and the second symmetric core portion 220) and so that part of the magnetic field lines pass through the inner gap 240 and through the outer gap 250.

Advantageously, as set out above, increasing the magnetic reluctance of the core comparatively increases the amount of energy stored in the core (e.g. stored in the combined system of the first symmetrical core portion 210 the second symmetrical core portion 220 and the gap). Energy is stored in the core in the form of a magnetic field.

Energy is stored at a greater density in the gap than in the first symmetric core portion 210 and second symmetric core portion 220.

In the event that a magnetic field is passed through the symmetric core and the gap, a an inner electromagnetic field (e.g. a magnetic field) is provided within the gap. e.g. the inner induced electromagnetic field is disposed between the first cylindrical projection 212 and the second cylindrical projection 222.

The inner electromagnetic field (e.g. magnetic field) comprises a central inner electromagnetic field 242 (e.g. a magnetic field) and a fringing inner electromagnetic field 245 (e.g. a magnetic field). The central inner electromagnetic field 242 is disposed within the inner gap 240. The fringing inner electromagnetic field 245 is disposed radially around the central inner induced electric field 242 (e.g. the fringing inner electromagnetic field 245 radially encloses the central inner electromagnetic field 242).

Field lines of the fringing inner electromagnetic field 245 connect the axial face of the first cylindrical projection 212 and the axial face of the second cylindrical projection 222.

The field lines of the fringing inner electromagnetic field 245 have a curved shape. A given field line of the fringing inner electromagnetic field 245 starts at an axial face of the first projecting cylindrical portion 212 moving radially outward until reaching an axial midpoint between the axial face of the first projecting cylindrical portion 212 and the axial face of the second projecting cylindrical portion 222. From the axial midpoint, the field line moves radially inward until reaching the axial face of the second projecting cylindrical portion 222. Put another way, a notional magnetic charge disposed at the axial face of the first projecting cylindrical portion will be moved by the field towards the axial face of the second projecting cylindrical portion along an arcing path which monotonically increases from the first projecting cylindrical portion to a maximum radial displacement when equidistant from the two axial faces and then monotonically decreases from the maximum radial displacement to the second projecting cylindrical portion.

Fringing fields formed at gaps in the core may intersect typical conductors (e.g. conductors without a change of pitch as set out above or conductors). In regions of typical conductors where intersection between the typical conductors and fringing fields occurs, eddy currents may be generated in these regions of the typical conductor thereby resulting in loses (e.g. loses in current flow through the typical conductor; energy losses from the typical conductor, for example, as a result of heating generated by the eddy currents).

FIG. 3A illustrates a first cross-sectional plan view of an inductor along plane A-A shown with respect to the conductor in FIG. 1C; FIG. 3B illustrates a second cross-sectional plan view of an inductor along plane B-B shown with respect to the conductor in FIG. 1E.

The inductor 300 comprises the conductor 100 illustrated in FIGS. 1A to 1E and the symmetric core 200A illustrated in FIGS. 2A to 2E.

The A portion 111A of conductor 100 is disposed in the first annular hollow 218 defined by the first symmetric core portion 210. The B portion 111B of conductor 100 is disposed in the second annular hollow 228 defined by the second symmetric core portion 220.

The conductor is configured to connect to a source of electromotive force (EMF). The conductor 100 is configured to generate a magnetic field when a current flows therethrough around the conductor e.g. magnetic field lines of the magnetic field form closed loops which pass through the central passage 108 around the outer radial surface 106 of the conductor and back through the central passage 108.

At least some of the generated magnetic field lines of the generated magnetic field pass through the symmetric core 200A. The magnetic field lines of the generated magnetic field are closed loops which pass from the central passage of the conductor 108, around an outer radial face 106 of the conductor and back into the central passage of the conductor 108. The magnetic field lines of the generated magnetic field intersect the first symmetric core portion 210 and the second symmetric core portion 220 and the magnetic field lines pass through the inner gap 240 and through the outer gap 250.

The volume of the helical conductor 100 (comprising a first region with a first pitch and a second region with a second pitch, wherein the second pitch is greater than the first pitch) which is disposed in the volume where the inner fringing field is disposed is comparatively reduced in comparison to typical helical conductors comprising a single pitch. Advantageously, the magnitude of interaction (i.e. electromagnetic interaction) between the fringing field and the conductor 100 is comparatively reduced relative to typical conductors comprising a single pitch.

Part of the second region 121 of the conductor 100 is disposed in the inner fringing 245 and the outer fringing field 255. The pitch of the second conductor is greater than the longitudinal length L_{G} of the inner gap. As the pitch of the second region 121 of the conductor 100 is greater than the longitudinal length L_{G} of the inner gap 240, the second region 121 only completes a partial turn in the gap between the first symmetric core portion 210 and the second symmetric core portion 220. Therefore, there are regions in the gap between the first symmetric core portion 210 and the second symmetric core portion 220 wherein no conductor is disposed. For example, the cross-section illustrated in FIG. 3B shows a region of the gap wherein the second region 121 of the conductor 100 is absent. Advantageously, the interaction between the second region 121 of the conductor 100 is reduced in comparison to a second region with a pitch which is less than or equal to the length of the gap L_{G}.

It is advantageous to provide a second region with a pitch which is greater than the length of the gap L_{G} and it is further advantageous to make the pitch of the second region as large as possible relative to the length of the gap L_{G}. The greater the pitch of the second region relative to the length of the gap, then the lesser the intersection and interaction of the fringing fields and the conductor e.g. the greater the pitch, the greater the proportion of the inductor with a cross-section such as that shown in FIG. 3B.

In examples, the conductor at the second core portion may be disposed such that the longer length X forms the inner radial surface of the helical conductor at the second region thereby increasing the inner radius of the helical conductor at the second region. Advantageously, the distance between the inner fringing field and the second region of the conductor may be increased (e.g. relative to conductors with second regions wherein the shorter length Y forms the inner radial surface of the helical conductor at the second region to thereby provide an inner radial surface of the second region having an inner radius less than the inner radius of a conductor wherein the longer length X forms the inner radial surface) thereby reducing the magnitude of interaction between the fringing field and the conductor.

An inductor, for example the inductor illustrated in FIGS. 3A and 3B, may be formed by a method comprising: disposing a first region of a conductor with around a core (e.g. around a cylindrical projecting portion of the first and/or second core portion), wherein the first region of the conductor is disposed around the core with a first pitch; disposing a second region of a conductor with around a gap in the core, wherein the second region of the conductor is disposed around the gap in the core with a second pitch, wherein the second pitch is greater than the first pitch.

In examples, the gap has a gap length (e.g. the shortest distance through the gap between the first portion and the second portion of the core) and the second pitch is greater than or equal to the gap length.

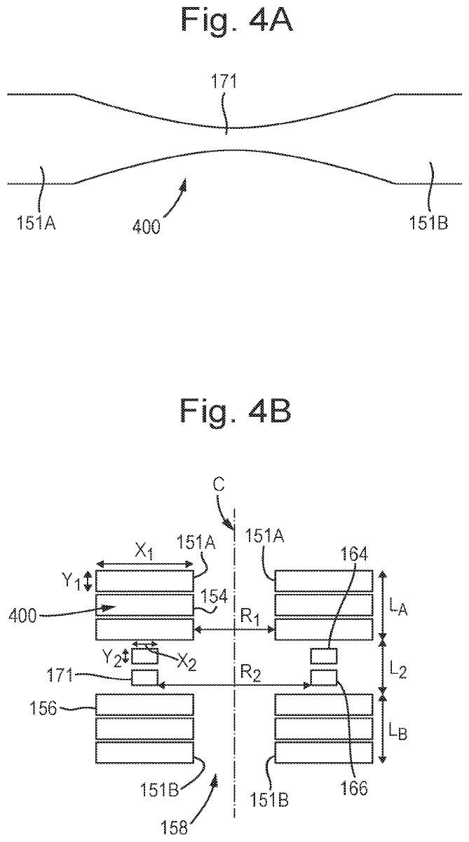

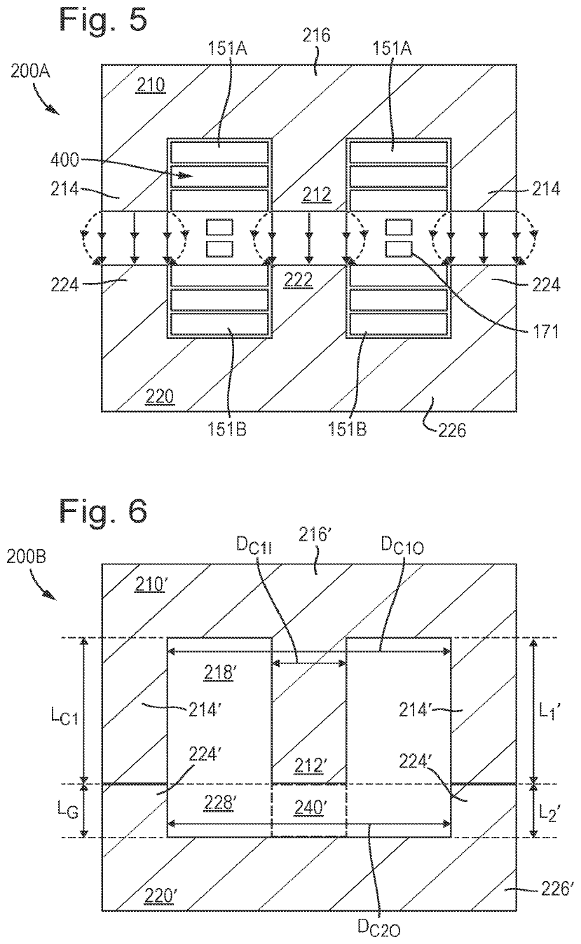

FIG. 4A illustrates a cross-sectional plan view of a portion of a conductor for an inductor, for example, the conductor is configured for disposal in the symmetric core shown in FIGS. 2A to 2C; FIG. 4B illustrates a cross-sectional plan view of the conductor of FIG. 4A. FIG. 5 illustrates a cross-sectional plan view of the conductor of FIG. 4 disposed in the symmetric core shown in FIGS. 2A to 2C.

The portion of the conductor 400 comprises: an A portion 151A of a first region of the conductor 400; a B portion 151B of a first region of the conductor 400; and a second region 171 of the conductor 400.

The A portion 151A is connected to the second region 171. The second region 171 is connected to the B portion 151B of the first region. The A portion 151A and the B portion 151B both have a first cross-sectional area. The second region 171 has a second cross-sectional area wherein the second cross sectional area is less than the first cross-sectional area.

The conductor 400 is arranged a helix to thereby provide a helical conductor comprising a first region 151A & 151B and a second region 171. In the example shown in FIG. 5, the helical conductor 400 has a single pitch e.g. the first region and the second region have the same pitch.

The first region 151A & 151B of the conductor 400 has a rectangular cross-section having a first cross-sectional area A₁. The rectangular cross-section is the same size in all parts of the first region. The rectangular cross-section is characterised by two pairs of sides wherein the sides of each pair have lengths X₁ (e.g. width) and Y₁ (e.g. height) respectively. The length X₁ is greater than length Y₁. The first cross-sectional area A₁ is equal to the product of the length X₁ and the length Y₁; A₁=X₁Y₁.

In examples, the length X₁ may be equal to the length Y₁ i.e. to give a conductor with a square cross section. In examples, the cross-section of the conductor may be circular.

The second region 171 of the conductor 400 has a rectangular cross-section having a second cross-sectional area A₂. The rectangular cross-section is the same size in all parts of the second region. The rectangular cross-section is characterised by two pairs of sides wherein the sides of each pair have lengths X₂ (e.g. width) and Y₂ (e.g. height) respectively. The length X₂ is greater than length Y₂. The second cross-sectional area A₂ is equal to the product of the length X₂ and the length Y₂; A₂=X₂Y₂.

In examples, the length X₂ may be equal to the length Y₂ i.e. to give a conductor with a square cross section. In examples, the cross-section of the conductor may be circular.

The second cross-sectional area A₂ is less than the first cross sectional area A₁ e.g. X₂Y₂<X₁Y₁.

The helical conductor has a central longitudinal axis C. The first region 151A & 151B has a first inner radial surface 154. The first inner radial surface 154 is disposed around the longitudinal axis C. The first region has a first inner radius R₁ defined as the shortest distance between a given point on the longitudinal axis C and the first inner radial surface 154. The first region has a first outer radial surface 156. The first outer radial surface 156 is disposed around the longitudinal axis C. The first region has a first outer radius R_{1O} defined as the shortest distance between a given point on the longitudinal axis C and the outer radial surface 106 wherein R_{1O}=R₁+X₁.

The second region 171 has a second inner radial surface 164. The first inner radial surface 164 is disposed around the longitudinal axis C. The second region has a second inner radius R₂ defined as the shortest distance between a given point on the longitudinal axis C and the second inner radial surface 164. The second region has a second outer radial surface 166. The second outer radial surface 166 is disposed around the longitudinal axis C. The second region has a second outer radius R_{2O} defined as the shortest distance between a given point on the longitudinal axis C and the second outer radial surface 166 wherein R_{2O}=R₂+X₂.

The helical conductor has a central longitudinal passage 158. The central longitudinal passage 158 is delimited by the first inner radial surface 154 of the first region of the helical conductor and the second inner radial surface 164 of the second region of the helical conductor.

The first region of the conductor is discontinuous e.g. the first region sandwiches the second region. In other words, the first region comprises two disconnected portions, an A portion 151A and a B portion 151B. The A portion 151A has a longitudinal length L_{A} parallel to the central longitudinal axis C. The B portion 151B has a longitudinal length L_{B} parallel to the central longitudinal axis C. The first region of the conductor has a longitudinal length L₁ which is equal to the sum of the longitudinal length L_{A} of the A portion 151A and the sum of the longitudinal length L_{B} of the B portion 111B; L₁=L_{A}+L_{B}.

The second region 171 of the conductor has a longitudinal length L₂, parallel to the longitudinal axis C.

The helical conductor 400 has a total longitudinal length L_{T} parallel to the longitudinal axis C. The total longitudinal length L_{T} of the helical conductor is equal to the sum of the lengths of the first region L₁ and the second region L₂; L_{T}=L₁+L₂. In the example shown in FIGS. 4A to 4B, the total longitudinal length L_{T} of the helical conductor is equal to the sum of the longitudinal length L_{A} of the A portion 151A, the longitudinal length L_{B} of the B portion 111B, and the longitudinal length L₂ of the second region 121; L_{T}=L_{A}+L_{B}+L₂. Put another way, the total longitudinal length L_{T} of the helical conductor is equal to the sum of the longitudinal length L₁ of the first region 151A & 151B and the longitudinal length L₂ of the second region 171; L_{T}=L₁+L₂.

The conductor 400 is configured to permit a current to flow therethrough e.g. when the conductor is connected to a source of electromotive force (EMF). The conductor 400 is configured to connect to a source of EMF e.g. the conductor 400 comprises electrical connections similar to electrical connections 102A and 102B shown in FIGS. 1A to 1E wherein the electrical connections are connectable to a source of EMF. The conductor 400 is configured to generate a magnetic field when a current flows therethrough wherein the magnetic field is disposed around the conductor e.g. magnetic field lines of the magnetic field form closed loops which pass through the central passage 158 around the outer radial surface 106 of the conductor and back through the central passage 158. In other words, the magnetic field lines are closed loops which enclose a portion of the conductor.

The symmetric core 200A is configured to engage a conductor, for example, the conductor 400 illustrated in FIG. 4. The first annular hollow 218 defined by the first symmetric core portion 210 is configured to receive a portion of a conductor, for example, the A portion 151A of conductor 400. The second annular hollow 228 defined by the second symmetric core portion 220 is configured to receive a portion of a conductor, for example, the B portion 151B of conductor 400. The gap between the first symmetric core portion 210 and the second symmetric core portion 220 is configured to receive a portion of the conductor, for example, the second region 151B of the conductor 100. Put another way, a portion of the conductor is configured to be disposed between the first symmetric core portion 210 and the second symmetric core portion 220, for example, the second region 171 of conductor 400. That is, a portion of the conductor is disposed between the first symmetric core portion 210 and the second symmetric core portion 220 but is not disposed in any of the first annular hollow, the second annular hollow, the inner gap or the outer gap.

FIG. 5 illustrates a cross-sectional plan view of the conductor of FIG. 4 disposed in the symmetric core shown in FIGS. 2A to 2C.

The A portion 151A of conductor 400 is disposed in the first annular hollow 218 defined by the first symmetric core portion 210. The B portion 151B of conductor 400 is disposed in the second annular hollow 228 defined by the second symmetric core portion 220.

The conductor is configured to connect to a source of electromotive force (EMF). The conductor 400 is configured to generate a magnetic field when a current flows therethrough around the conductor e.g. magnetic field lines of the magnetic field form closed loops which pass through the central passage 158 around the first outer radial surface 156 and second outer radial surface 166 of the conductor 400 and back through the central passage 158.

At least some of the generated magnetic field lines of the generated magnetic field pass through the symmetric core 200A. The magnetic field lines of the generated magnetic field are closed loops which pass from the central passage of the conductor 158, around the first outer radial face 156 and second outer radial face 166 of the conductor 400 and back into the central passage 158 of the conductor 400. The magnetic field lines of the generated magnetic field intersect the first symmetric core portion 210 and the second symmetric core portion 220 and the magnetic field lines pass through the inner gap 240 and through the outer gap 250.

The volume of the helical conductor 400 (comprising a first region with a first cross-sectional area and a second region with a second cross-sectional area, wherein the second cross-sectional area is less than the first cross-sectional area) which is disposed in the volume wherein the inner fringing field is disposed is comparatively reduced in comparison to typical helical conductors comprising a single cross-sectional area. Advantageously, the magnitude of interaction (i.e. electromagnetic interaction) between the fringing field and the conductor 400 is comparatively reduced relative to typical conductors comprising a single cross-sectional area.

In the example shown in FIG. 5 the second region 171 of the conductor 400 is not disposed in the inner fringing 245 and the outer fringing field 255. Advantageously, the interaction between the second region 171 of the conductor 400 is reduced in comparison to a second region with a cross-sectional area greater than of the second region 171 of conductor 400 (e.g. such as the first region).

In examples, the volume of the second region 171 which is disposed in the fringing fields is comparatively reduced relative to a typical conductor comprising a single cross-sectional area throughout.

In examples, the first region with a first cross-sectional area has a first pitch and the second region with a second cross-sectional area (wherein the second cross-sectional area A₂ is less than the first cross-sectional area) has a second pitch wherein the second pitch is greater than the first pitch. In such examples, the volume of the helical conductor (comprising a first region having a first cross-sectional area with a first pitch and a second region having a second cross-sectional area with a second pitch) which is disposed in the volume wherein the inner fringing field is disposed is comparatively reduced in comparison to typical helical conductors comprising a single pitch and/or typical conductors comprising a single cross-sectional area. Advantageously, the magnitude of interaction (i.e. electromagnetic interaction) between the fringing field and the conductor is comparatively reduced relative to typical conductors comprising a single pitch and/or a single cross-sectional area.

An inductor, for example the inductor illustrated in FIG. 5, may be formed by a method comprising: disposing a first region of a conductor with around a core, wherein the first region of the conductor has first cross-sectional area; disposing a second region of a conductor around a gap in the core, wherein the second region of the conductor has a second cross-sectional area wherein the second cross-sectional area is less than the first cross-sectional area.

In examples, the method may comprise: providing a conductor having a first region and a second region; and, compressing second region of an inductor.

In examples, the gap has a gap length (e.g. the shortest distance through the gap between the first portion and the second portion of the core) and, the second pitch is greater than or equal to the gap length.

FIG. 6 illustrates a cross-sectional plan view of an asymmetric core for an inductor.

The asymmetric core 200B comprises: a first asymmetric core portion 210′; and, a second asymmetric core portion 220′.

The first asymmetric core portion 210′ comprises: a first end portion 216′; a first cylindrical projection 212′; and, a first annular cylindrical projection 214′. The first cylindrical projection 212′ is connected to the first end portion 216′. The first annular cylindrical projection 214′ is connected to the first end portion 216′. The first cylindrical projection 212′ and the first annular cylindrical projection 214′ are disposed concentrically i.e. the first cylindrical projection 212′ and the first annular cylindrical projection 214′ are arranged so that a longitudinal axis of the first cylindrical projection 212′ and a longitudinal axis of the first annular cylindrical projection 214′ are parallel and coincident. The first cylindrical projection 212′ and the first annular cylindrical projection 214′ are disposed concentrically to thereby provide a first annular hollow 218′ therebetween.

The first end portion 216′ has a cylindrical shape and the first cylindrical projection 212′ and the first annular cylindrical projection 214′ are disposed on an axial face of the first end portion 216′. The first end portion 216′ has a diameter equal to the outer diameter of the first annular cylindrical projection 214′.

The first cylindrical projection 212′ has a diameter D_{C1I}′. The first annular cylindrical projection 214′ has an inner diameter D_{C1O}′. The diameter D_{C1I}′ of the first cylindrical projection 212′ is less than the inner diameter D_{C1O}′ of the first annular cylindrical projection 214′.

The first cylindrical projection 212′ has a length L_{C1}′. In other words, the first cylindrical projection 212 extends longitudinally from the first end portion 216 by a length L_{C1}′. The first annular cylindrical projection 214′ has a length L_{C1}′. In other words, the first annular cylindrical projection 214′ extends longitudinally from the first end portion 216′ by a length L_{C1}′.

The first annular hollow defined by the first asymmetric core portion 210′ has: a length equal to the length L_{C1}′ of the first cylindrical projection 212′; an inner diameter equal to the diameter D_{C1I}′ of the first cylindrical projection 212′; an outer diameter equal to the inner diameter D_{C1O}′ of the first annular cylindrical projection 214′.

The second asymmetric core portion 220′ comprises: a second end portion 226′; and, a second annular cylindrical projection 224′. The second annular cylindrical projection 224′ is connected to the second end portion 226′. The second annular cylindrical projection 224′ provides a second cylindrical hollow 228′ therebetween.

The second end portion 226′ has a cylindrical shape and the second annular cylindrical projection 224′ is disposed on an axial face of the second end portion 226′. The second end portion 226′ has a diameter equal to the outer diameter of the second annular cylindrical projection 224′.

The second annular cylindrical projection 224′ has an inner diameter D_{C2O}′.

The second annular cylindrical projection 224 has a length L_{G}. In other words, the second annular cylindrical projection 224′ extends longitudinally from the second end portion 226′ by a length L_{G}.

The second cylindrical hollow 228′ defined by the second asymmetric core portion 220′ has: a length equal to the length L_{G} of the second annular projection 224′; an inner diameter equal to the diameter D_{C2O} of the second annular projection 224′.

In the asymmetric core 200B: the inner diameter D_{C1O} of the first annular cylindrical projection 214′ is equal to the inner diameter D_{C2O} of the second annular cylindrical projection 224′; the outer diameter of the first annular cylindrical projection 214′ is equal to the outer diameter of the second annular cylindrical projection 224′.

The asymmetric core 200B is configured to receive a helical conductor comprising a first region and a second region wherein the first region is continuous (i.e. not comprising an A portion and a B portion separated by the second region, but rather a (unitary) first region adjacent a second region) wherein the helical conductor has at least one of the following a features: the first region having a first pitch and the second region having a second pitch wherein the second pitch is greater than the first pitch; and, a second region having a first cross-sectional area and the second region having a second cross-sectional area wherein the second cross-sectional area is less than the first cross-sectional area. Such a helical conductor is referred to herein as a continuous helical conductor. The first region of the continuous helical conductor having a longitudinal length of L₁′ and the second region of the continuous helical conductor having a longitudinal length of L₂′.

The first annular hollow 218′ is configured to receive a first region of a continuous helical conductor. The second cylindrical hollow 228′ is configured to receive a second region of a continuous helical conductor.

The longitudinal length of the first annular hollow 218′ is equal to that of the first cylindrical projecting portion 212′ L_{C1}. The longitudinal length of the second cylindrical hollow 228′ is equal to that of the second annular projecting portion 224′ L_{C2}. The longitudinal length of the first annular hollow 218′ is equal to that of the first region L₁′ of the conductor. The longitudinal length of the second cylindrical hollow 228′ is equal to that of the second region L₂′ of the conductor.

The diameter D_{C1I} of the first cylindrical projection 212′ is less than or equal to twice the inner radius of the conductor. The diameter D_{C2I} of the second annular projection 224′ is less than or equal to twice the inner radius of the conductor. The inner diameter D_{C1O} of the first annular cylindrical projection 214′ is greater than or equal to twice the outer radius of the conductor. The inner diameter D_{C2O} of the second annular cylindrical projection 224′ is greater than or equal to twice the outer radius of the conductor.

The first asymmetric core portion 210′ and the second asymmetric core portion 220′ are arranged to provide a gap therebetween. The first asymmetric core portion 210′ and the second asymmetric core portion 220′ are arranged to provide an inner gap 240′ directly between the first cylindrical projection 212′ and the second end portion 226′.

The inner gap 240′ is a cylindrical gap of diameter D_{C1I}′ which is disposed between axial faces of the first cylindrical projection 212′ and the second end portion 226′.

In examples, the first asymmetric core portion and the second asymmetric core portion are arranged to provide an inner gap between the first cylindrical projection and the second end portion 226′ and also an outer gap provided between the first annular cylindrical projection and the second annular cylindrical projection. In such examples, the sum of the longitudinal lengths of the first annular cylindrical projection and the second annular cylindrical projection is less than the longitudinal length of the helical conductor. For example, the symmetric core illustrated in FIGS. 2A to 2C does include an outer gap.

The inner gap 240′ is configured to increase the magnetic reluctance of the core (e.g. the combined magnetic reluctance of combined system of the first asymmetrical core portion 210′ the second asymmetrical core portion 220′ and the gap 240′).

Advantageously, increasing the magnetic reluctance of the core 200B comparatively increases the amount of energy stored in the core 200B (e.g. the energy stored in the combined system of the first asymmetrical core portion 210′ the second asymmetrical core portion 220′ and the gap 240′). Energy is stored in the core 200B in the form of a magnetic field.

Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

The specification is understood with reference to the following numbered paragraphs:

Numbered Paragraph 1: An inductor comprising:
a helical conductor encircling a central longitudinal axis;
a core having a core magnetic reluctance, the core comprising:
a first core portion;
a second core portion; and,
a gap disposed between the first core portion and the second core portion and enclosed by the helical conductor, wherein the gap is configured to provide a gap magnetic reluctance wherein the gap magnetic reluctance is greater than the core magnetic reluctance;
wherein the helical conductor has:
a first region of the conductor which encloses part of the core, wherein the first region comprises a first pitch; and,
a second region of the conductor which encloses the gap wherein the second region comprises a second pitch, wherein the second pitch is greater than the first pitch;
wherein, in use, the second region of the conductor is configured to reduce a magnitude of interaction between the second region of the conductor and the electromagnetic field generated around the gap.

Numbered Paragraph 2: The inductor of Numbered Paragraph 1, wherein:
the gap has a gap length, wherein the gap length is the shortest distance through the gap between the first core portion and the second core portion; and,
the second pitch is greater than or equal to the gap length.

Numbered Paragraph 3: the inductor of any of the preceding Numbered Paragraphs, wherein:
the conductor has a rectangular cross-section comprising two sides with length X and two sides with length Y, wherein length X is greater than length Y.

Numbered Paragraph 4: The inductor of Numbered Paragraph 3, wherein:
the second region of the conductor is arranged so that one of the sides of the conductor with length X forms part of an inner radial surface of the helical conductor.

Numbered Paragraph 5: the inductor of any of the preceding Numbered Paragraphs, wherein:
the radial distance between the central longitudinal axis and the inner radial surface is greater at the second region of the conductor than the first region of the conductor.

Numbered Paragraph 6: A method of forming an inductor, the method comprising:
disposing a first region of a conductor around a core, wherein the first region of the conductor is disposed around the core with a first pitch;
disposing a second region of a conductor around a gap in the core, wherein the second region of the conductor is disposed around the gap in the core with a second pitch, wherein the second pitch is greater than the first pitch.

Numbered Paragraph 7: the method of Numbered Paragraph 6, wherein:
the gap has a gap length, wherein the gap length is the shortest distance through the gap between the first core portion and a second core portion; and,
the second pitch is greater than or equal to the gap length

Numbered Paragraph 8: an inductor comprising:
a helical conductor;
a core having a core magnetic reluctance, the core comprising:
   a first core portion;
   a second core portion; and,
   a gap disposed between the first portion and the second portion and enclosed by the helical conductor, wherein the gap is configured to provide a gap magnetic reluctance wherein the gap magnetic reluctance is greater than the core magnetic reluctance;
wherein the helical conductor has:
   a first region of the conductor which encloses part of the core, wherein the first region comprises a first pitch, and wherein the first region of the conductor has a first cross-sectional area; and,
   a second region of the conductor which encloses the gap wherein the second region comprises a second pitch, wherein the second pitch is greater than the first pitch, and wherein the second region of the conductor has a second cross-sectional area wherein the second region cross-sectional area is less than the first cross-sectional area;
   wherein, in use, the second region of the conductor is configured to reduce a magnitude of interaction between the second region of the conductor and an electromagnetic field generated around the gap.

Numbered Paragraph 9: The inductor of any of the preceding Numbered Paragraphs, wherein:
the radial distance between the central longitudinal axis and the inner radial surface is greater at the second region of the conductor than the first region of the conductor.

Numbered Paragraph 10: a method of forming an inductor, the method comprising:
disposing a first region of a conductor around a core, wherein the first region of the conductor has a first cross-sectional area;
disposing a second region of a conductor around a gap in the core, wherein the second region of the conductor has a second cross-sectional area wherein the second cross-sectional area is less than the first cross-sectional area.

Numbered Paragraph 11: The method of Numbered Paragraph 10, comprising:
providing a conductor having a first region and a second region; and,
compressing the second region of an conductor.

Numbered Paragraph 12: the method of any one of Numbered Paragraphs 10 to 11, wherein:
the gap has a gap length, wherein the gap length is the shortest distance through the gap between a first core portion and a second core portion; and,
   the second region of the conductor has a pitch which is greater than or equal to the gap length.

1. An inductor comprising:
a helical conductor encircling a central longitudinal axis;
a core having a core magnetic reluctance, the core comprising:
a first core portion;
a second core portion; and,
a gap disposed between the first core portion and the second core portion and enclosed by the helical conductor, the gap is configured to provide a gap magnetic reluctance, and the gap magnetic reluctance is greater than the core magnetic reluctance;
wherein the helical conductor has:
a first region of the conductor which encloses part of the core, and the first region comprises a first pitch; and,
a second region of the conductor which encloses the gap, the second region comprises a second pitch, and the second pitch is greater than the first pitch;
wherein, in use, the second region of the conductor is configured to reduce a magnitude of interaction between the second region of the conductor and the electromagnetic field generated around the gap, and the radial distance between the central longitudinal axis and the inner radial surface is greater at the second region of the conductor than the first region of the conductor.

2. The inductor of claim 1, wherein the first region of the conductor has a first cross-sectional area, the second region of the conductor has a second cross-sectional area, and the second region cross-sectional area is less than the first cross-sectional area.

3. The inductor of claim 1, wherein the radial distance between the central longitudinal axis and the inner radial surface is greater at the second region of the conductor than the first region of the conductor.

4. A method of forming an inductor, the method comprising:
disposing a first region of a conductor around a core, the first region of the conductor is disposed around the core with a first pitch; and
disposing a second region of a conductor around a gap in the core, the second region of the conductor is disposed around the gap in the core with a second pitch, and the second pitch is greater than the first pitch.

5. The method of claim 4, wherein the gap has a gap length, the gap length is the shortest distance through the gap between the first core portion and a second core portion, and the second pitch is greater than or equal to the gap length.

6. A method of forming an inductor, the method comprising:
disposing a first region of a conductor around a core, the first region of the conductor has a first cross-sectional area; and
disposing a second region of a conductor around a gap in the core, the second region of the conductor has a second cross-sectional area, and the second cross-sectional area is less than the first cross-sectional area.

7. The method of claim 6, further comprising providing a conductor having a first region and a second region; and, compressing the second region of the conductor.

8. The method of claim 6, wherein the gap has a gap length, the gap length is the shortest distance through the gap between a first core portion and a second core portion, and the second region of the conductor has a pitch which is greater than or equal to the gap length.
